(19) United States
(12) Patent Application Publication
(10) Pub. No.: US 2007/0281548 A1
(43) Pub. Date: Dec. 6, 2007

(54) ELECTRICAL CONNECTOR WITH DIFFERING CHANNEL AND SIGNAL TERMINAL STRUCTURES

(75) Inventor: Ted Ju, Keelung (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Lotes Co., Ltd.

(21) Appl. No.: 11/446,388

(22) Filed: Jun. 5, 2006

(51) Int. Cl. H01R 13/648

(52) U.S. Cl. 439/608

(57) ABSTRACT

The present invention discloses an electrical connector provided with a plurality of terminals, each of which is provided with a connecting arm, respectively, wherein one end of the connecting arm is formed with a securing arm and an elastic arm and an angle between the securing arm and the elastic arm is formed; the terminal comprises a plurality of channel terminals and a plurality of signal terminals, wherein the bending point of the channel terminal is higher than that of the signal terminal; the terminal is provided with a contact, wherein the first contact of the first terminal is located above the second contact of the second terminal and the first contact is in contact with the second contact under pressure. The advantage of the present invention includes the followings: since the terminal comprising different structures of the channel terminal and the signal terminal and the heights of the channel terminal and the signal channel are different after bending, the terminal can have a variety of shapes and a simple overall structure; the terminal is formed integratedly with the terminal blank so as to make ease of the assembly, enhance production efficiency, reduce production cost, and effectively increase assembly quality and quantity.

### FIELD OF THE INVENTION

The present invention relates to an electrical connector and, in particular, to an electrical connector in which the structures of the channel terminal and the signal terminal are different, the heights of the channel terminal and the signal channel are different after bending, and the terminals can have a variety of shapes and a simple overall structure.

### BACKGROUND OF THE INVENTION

With rapid development of various electronic products and personal multimedia computers recently, the audio jack connector has been widely employed in these industries. Furthermore, with the extension of electronic products to their peripherals, the demands in quality and function for the audio jack connector have been getting higher.

Existing audio jack connector generally comprises four signal terminals and one ground terminal, wherein the structure of the ground terminal is generally simple and easily fabricated, and the audio jack connector is usually a stacking configuration usually comprising three jack interfaces. Therefore, four corresponding sets of the signal terminals are required. Each set of the signal terminal comprises three terminals and has different bending heights of terminals from top to bottom. Since each terminal is independently fabricated, each terminal has to be inserted into its corresponding receiving socket separately.

ROC Patent No. 545773, a conventional electrical connector, for example, discloses a triple audio jack, comprising a base 1, a core 2, and five sets of terminals 4-8 disposed in the base 1 and the core 2, wherein the third set of the terminal 6 is a ground terminal and the remaining four sets of terminal are signal terminals. Since each set of the signal terminals 4, 5, 7, and 8 has three terminals, each terminal has to be inserted into their corresponding through holes and sockets in the base 1 and the core 2 separately; thus, each terminal has to be fabricated independently. Consequently, the structure of the terminals is complicated and it is inconvenient to insert each terminal into its corresponding through hole and socket, leading to inconvenience in manufacturing as well as high production cost.

Consequently, it is necessary to design a new electrical connector to overcome the shortcomings described above.

### SUMMARY OF THE INVENTION

An object of the present invention is to provide an electrical connector with a simple terminal structure.

Another object of the present invention is to provide an electrical connector which can make the terminal assembly easy and enhance production efficiency.

To achieve the objects described above, the electrical connector according to the present invention is provided with a plurality of terminals, each of which is provided with a connecting arm, respectively, wherein one end of the connecting arm is formed with a securing arm and an elastic arm, and an angle between the securing arm and the elastic arm is formed.

To achieve the objects described above, the electrical connector according to the present invention is provided with a plurality of terminals, each of which comprises a plurality of channel terminals and a plurality of signal terminals, wherein the bending point of the channel terminal is higher than that of the signal terminal.

To achieve the objects described above, the present invention provides an electrical connector provided with a plurality of terminals, each of which is disposed with a contact, whose bending point is in a different height, wherein the first contact of the first terminal is located above the second contact of the second terminal and the first contact is in contact with the second contact under pressure.

Compared with conventional prior art, the electrical connector according to present invention includes the following advantages: since the terminal comprising different structures of the channel terminal and the signal terminal and the heights of the channel terminal and the signal channel are different after bending, the terminal can have a variety of shapes and a simple overall structure; the terminal is formed integratedly with the terminal blank so as to make ease of the assembly, enhance production efficiency, reduce production cost, and effectively increase assembly quality and quantity.

### BRIEF DESCRIPTION OF THE DRAWINGS

The present invention can be more fully understood by reference to the following description and accompanying drawings, in which:

FIG. 1 schematically illustrates an exploded perspective view of a preferred embodiment of an electrical connector according to the present invention;

FIG. 2 schematically illustrates a perspective assembly view of the electrical connector of FIG. 1;

FIG. 3 schematically illustrates a local assembly view of the electrical connector of FIG. 1;

FIG. 4 schematically illustrates a perspective view of the terminals of the electrical connector of FIG. 1;

FIG. 5 schematically illustrates the terminal and the terminal blank on the top row of FIG. 4;

FIG. 6 schematically illustrates the terminal and the terminal blank on the middle row of FIG. 4; and

FIG. 7 schematically illustrates the terminal and the terminal blank on the bottom row of FIG. 4.

### DETAILED DESCRIPTION OF THE INVENTION

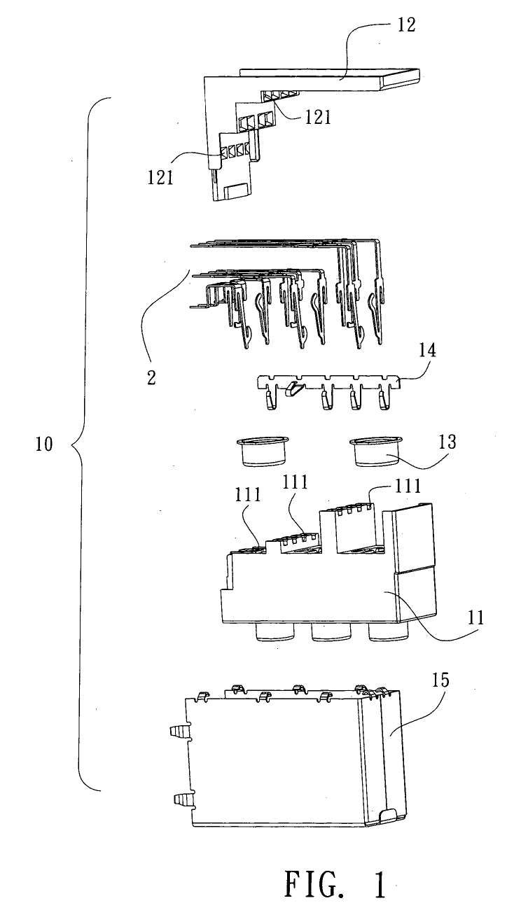

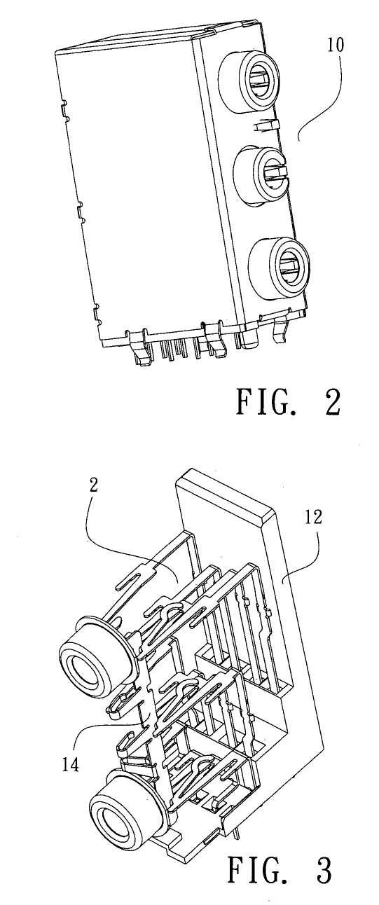

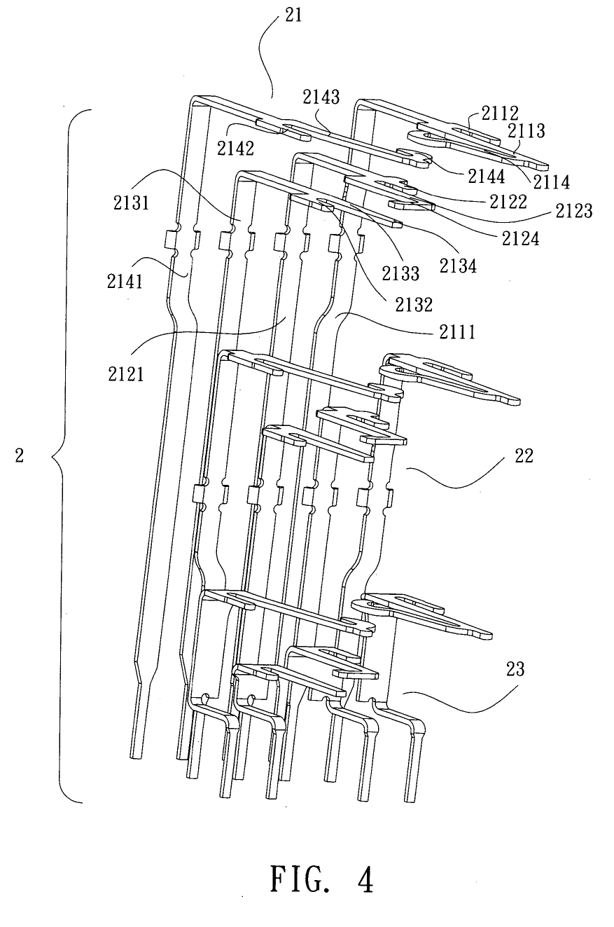

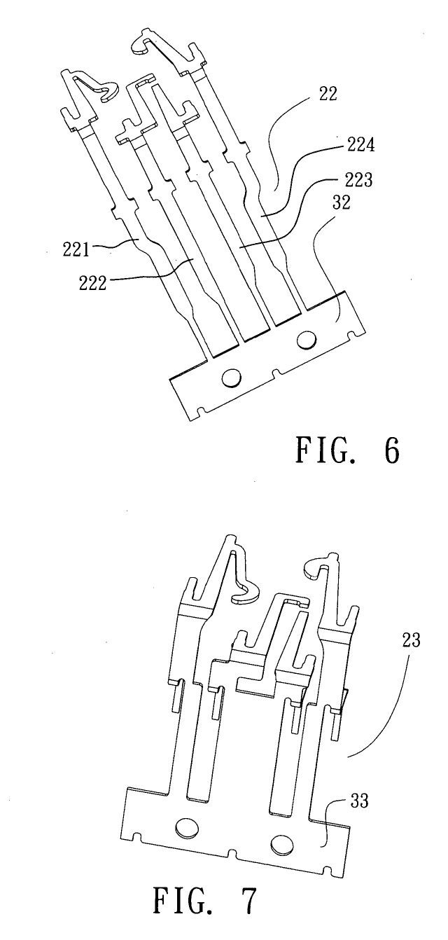

Referring to FIGS. 1 to 7, an electrical connector according to the present invention 10 comprises a body 11, a rear base 12, a ring 13, three rows (top, middle, and bottom) of channel terminal and signal terminal 2, a ground terminal 14, and a shield housing 15 mounted on the exterior of the body 11 and the rear base 12, wherein the rear end plane of the body 11 is provided with a receiving chamber 111 to receive the top, middle, and bottom rows of terminals; the rear base 12 is also provided with three rows of corresponding terminal receiving holes 121, and the ground terminal 14 is received in the body 11 and in contact with the channel terminal and signal terminal 2 and the ring 13, respectively.

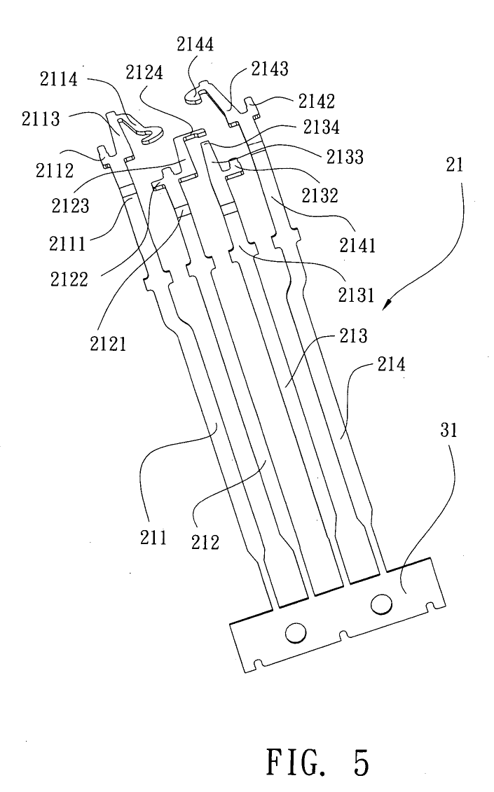

As shown in FIGS. 5 to 7, the channel terminal and signal terminal 2 is integratedly formed on the terminal blanks. The top row of channel terminal and signal terminal 21, for example, is integratedly formed on the terminal blank 31; The middle row of channel terminal and signal terminal 22, for example, is integratedly formed on the terminal blank 32; The bottom row of channel terminal and signal terminal 23, for example, is integratedly formed on the terminal blank 33; each terminal blank comprises, for example but not limited to, four terminals as a set, and each terminal has different shapes. Two channel terminals on the respective external side of the terminal blank are the channel terminals and the other two terminals on the middle of the terminal blank are the signal terminals.

The terminal blank 31, for example, is taken as an example for explanation (referring to FIG. 5). There are four terminals as a set of top row of the channel terminal and signal terminal 21 integratedly formed on the terminal blank 31. Since the channel terminals are on the outside of the signal terminals, the four terminals 21 from left to right are the first channel terminal 211, the first signal terminal 212, the second signal terminal 213, and the second channel terminal 214.

Each of the four terminals 211, 212, 213, and 214 is provided with connecting arms 2111, 2121, 2131, and 2141, respectively; and securing arms 2112, 2122, 2132, and 2142 and an elastic arm 2113, 2123, 2133, and 2143 dividingly formed from the connecting arms 2111, 2121, 2131, and 2141, respectively. An angle is formed between the securing arms 2112, 2122, 2132, 2142 and the elastic arms 2113, 2123, 2133, 2143, respectively.

The elastic arms 2113, 2123, 2133, 2143, are further provided with contacts 2114, 2124, 2134, and 2144, respectively (the contacts 2124 and 2134 of the signal terminals 212 and 213 are also named as the first contact 2114 and 2124, respectively). The securing arms 2112 and 2142 of the channel terminals 211 and 214 and the elastic arms 2113 and 2143 are oppositely located; that is, the securing arm 2113 of the first channel terminal 211 and the securing arm 2143 of the second channel terminal 214 are located on the respective external side of the terminal blank 31 and the contacts 2114 and 2144 are bendingly formed from the elastic arms 2113 and 2143, respectively. Since the contacts 2114 and 2144 have different shapes, the channel terminals 211 and 214 have different structures.

The securing arms 2122 and 2132 of the channel terminals 212 and 213 and the elastic arms 2123 and 2133 are also oppositely located; that is, the securing arm 2113 of the first channel terminal 211 and the securing arm 2122 of the first channel terminal 212 are adjacently located; the elastic arm 2123 of the first signal terminal 212 and the elastic arm 2133 of the second channel terminal 213 are adjacently located; and the securing arm 2132 of the second signal terminal 213 and the elastic arm 2143 of the second channel terminal 214 are adjacently located.

The first contact 2124 of the first signal terminal 212 is bendingly formed from the elastic arm 2123; however, the shapes of the first contact 2124 and the contacts 2114 and 2144 of the channel terminals 211 and 214 are not the same. The second contact 2134 of the second signal terminal 213 is located on the end of the elastic arm 2133. Therefore, the signal terminals 212 and 213 have different structures, and the structures of the channel terminals 211 and 214 and the signal terminals 212 and 213 are not the same.

When the terminal is being formed, the connecting arms 2111, 2121, 2131, and 2141 have a “ [symbol] ” shape and the bending points of the channel terminals 211 and 214 are higher than those of the channel terminals 212 and 213, and the bending points of the channel terminals 211 and 214 provided on the respective external side of the terminal blank 31 are located at the same height. On the other hand, the bending points of the signal terminals 212 and 213 provided on the middle of the terminal blank 31 are located at different heights, and the bending point of the first signal terminal 212 is higher than that of the second channel terminal 213.

Consequently, the first contact 2124 of the first signal terminal 212 is higher than the second contact 2134 of the second signal terminal 213. When an external device (not shown) is inserted into the electrical connector 10 according to the present invention, the external device will be in contact with the first channel terminal 211, the second channel 214, and the first signal terminal 212, respectively, and press downward the first signal channel 211 such that the first contact 2124 of the first signal terminal 212 is in contact with the second contact 2134 of the second signal terminal 213, achieving an electrical contact with the channel terminal and signal terminal 2.

The channel terminal and signal terminal 22 on the middle row is integratedly formed on the terminal blank 32. The channel terminal and signal terminal 22 comprises the first channel terminal 221 and the second channel terminal 224 on the respective external side of the terminal blank 32 as well as the first signal terminal 222 and the second signal terminal 223 on the middle of the terminal blank 32. The structures of the four terminals on the middle row 22 are basically the same with those of the four terminals on the top row 21; the only difference is that the overall structure of the four terminals on the middle row 22 is smaller that that of the four terminals on the top row 21. Consequently, no further details of the four terminals on the middle row 22 will be given here.

The channel terminal and signal terminal 23 on bottom row is integratedly formed on the terminal blank 33. The structures of the four terminals on the bottom row 23 are basically the same with those of the four terminals on the top row 21; the differences are that the overall structure of the four terminals on the bottom row 23 are smaller that that of the four terminals on the top row 21 and the connecting arms of the four terminals on the top row are bended into a “ [symbol] ” shape. Consequently, no further details of the four terminals on the bottom row 23 will be given here.

When being assembled, the terminals 21, 22, and 23 on the terminal blanks 31, 32, and 33, respectively, are first inserted into the corresponding terminal receiving chamber 111 and then the terminal blanks 31, 32, and 33 are snapped. Finally, the tops of the connecting arms 2111, 2121, 2131, and 2141 are inserted into the corresponding terminal receiving holes 121, so as to insert the terminal 2 into the jack connector 40.

The electrical connector according to the present invention comprises different structures of the channel terminal and the signal terminal, and the heights of the channel terminal and the signal channel are different after bending; the terminals can therefore have a variety of shapes and a simple overall structure and the terminals are formed integratedly with the terminal blanks so as to make ease of the assembly, enhance production efficiency, reduce production cost, and effectively increase assembly quality and quantity. Consequently, by putting the electrical connector according to the present invention, it can indeed overcome the shortcomings of the conventional prior art of electrical connector.

While the invention has been described with reference to the a preferred embodiment thereof, it is to be understood that modifications or variations may be easily made without departing from the spirit of this invention, which is defined by the appended claims.

1. An electrical connector provided with a plurality of terminals, each of which is provided with a connecting arm, wherein one end of the connecting arm is formed with a securing arm and an elastic arm, and an angle between the securing arm and the elastic arm is formed.

2. The electrical connector according to claim 1, wherein the securing arm and the elastic arm are dividingly formed from the connecting arm.

3. The electrical connector according to claim 1, wherein the elastic arm is further provided with a contact.

4. The electrical connector according to claim 1, wherein the terminal connected with a terminal blank further comprises a plurality of signal terminals and a plurality of channel terminals provided on the external sides of the signal terminals.

5. The electrical connector according to claim 4, wherein the signal terminals have different structures.

6. The electrical connector according to claim 4, wherein the channel terminals have different structures.

7. An electrical connector comprising a plurality of signal terminals and a plurality of channel terminals, wherein bending points of the channel terminals is higher than that of the signal terminals, wherein the signal terminals and the channel terminals are connected on the same terminal blank and the signal terminals are directly adjacent to one another, one of the channel terminals being located on each side of the signal terminals.

8. The electrical connector according to claim 7, wherein heights of the bending points of the signal terminals are different.

9. (canceled)

10. The electrical connector according to claim 7, wherein the channel terminals have different structures.

11. The electrical connector according to claim 7, wherein the signal terminals have different structures.

12. The electrical connector according to claim 7, wherein each of the signal and channel terminals formed by a connecting arm as well as a securing arm and an elastic arm dividingly formed from the connecting arm.

13. The electrical connector according to claim 12, wherein the elastic arm is further provided with a contact.

14. The electrical connector according to claim 12, wherein the connecting arm is bended to be a “ [symbol] ” shape.

15. An electrical connector provided with a plurality of terminals, each of which is provided with a contact and has a different height of the bending point, wherein a first contact of a first terminal is located above a second contact of a second terminal, and the first contact is configured to be selectively in contact with the second contact when under pressure.

16. The electrical connector according to claim 15, wherein the each terminal is formed by a connecting arm as well as a securing arm and an elastic arm dividingly formed from the connecting arm.

17. The electrical connector according to claim 16, wherein the elastic arm of the first terminal and the elastic arm of the second terminal are adjacently located.

18. The electrical connector according to claim 16, wherein the contact is extendingly formed from the elastic arm.

19. The electrical connector according to claim 16, wherein the connecting arm has a “ [symbol] ” shape.

20. The electrical connector according to claim 15, wherein the terminals connected with a terminal blank further comprise a plurality of signal terminals located directly adjacent to one another and a plurality of channel terminals with one channel terminal being located on each side of the signal terminals.
